(19) United States
(12) Patent Application Publication
(10) Pub. No.: US 2019/0315319 A1
(43) Pub. Date: Oct. 17, 2019

(54) Systems, Devices, and/or Methods for Managing Truck Trailers

(71) Applicant: Craig Williams, Columbia, MO (US)

(72) Inventor: Craig Williams, Columbia, MO (US)

(21) Appl. No.: 16/383,639

(22) Filed: Apr. 14, 2019

Related U.S. Application Data
(60) Provisional application No. 62/657,861, filed on Apr. 15, 2018.
(60) Provisional application No. 62/695,183, filed on Jul. 8, 2018.

(51) Int. Cl. B60S 9/12; B62D 63/08; B60S 9/04; B60Q 5/00

(52) U.S. Cl. CPC B60S 9/12; B60Q 5/005; B60S 9/04; B62D 63/08

(57) ABSTRACT

Certain exemplary embodiments can provide a system comprising a Trailer. The Trailer is coupleable to a tractor. The Trailer comprises a pair of dollies. Each of the pair of dollies can comprise a support shaft and a footpad. The system comprises a single shaft that is coupled to a jack of each of the pair of dollies.

### CROSS-REFERENCES TO RELATED APPLICATIONS

This application claims priority to, and incorporates by reference herein in its entirety, pending U.S. Provisional Patent Application Ser. No. 62/657,861 (1289-01), filed Apr. 15, 2018. This application claims priority to, and incorporates by reference herein in its entirety, pending U.S. Provisional Patent Application Ser. No. 62/695,183 (1289-02), filed Jul. 8, 2018.

### BRIEF DESCRIPTION OF THE DRAWINGS

FIGS. 1A-1E and FIGS. 1I and 2-16 are executed in color. A wide variety of potential practical and useful embodiments will be more readily understood through the following detailed description of certain exemplary embodiments, with reference to the accompanying exemplary drawings in which:

FIG. 1A is a photograph of an exemplary embodiment of a system 100;

FIG. 1B is a photograph and block diagram of an exemplary embodiment of a trailer 200;

FIG. 1C is a photograph of an exemplary embodiment of a system 300;

FIG. 1D is a photograph of an exemplary embodiment of a system 400;

FIG. 1E is a photograph of an exemplary embodiment of a system 500;

FIG. 1F is a block diagram of an exemplary embodiment of a system 600;

FIG. 1G is a block diagram of an exemplary embodiment of an information device 700; and

FIG. 1H is a flowchart of an exemplary embodiment of a method 800

FIG. 1I is a photograph of an exemplary embodiment of a system 900;

FIG. 2 is a photograph of an exemplary embodiment of a system 2000;

FIG. 3 is a photograph of an exemplary embodiment of a system 3000;

FIG. 4 is a photograph of an exemplary embodiment of a system 4000;

FIG. 5 is a photograph of an exemplary embodiment of a system 5000;

FIG. 6 is a photograph of an exemplary embodiment of a system 6000;

FIG. 7 is a photograph of an exemplary embodiment of a system 7000;

FIG. 8 is a photograph of an exemplary embodiment of a system 8000;

FIG. 9 is a photograph of an exemplary embodiment of a system 9000;

FIG. 10 is a photograph of an exemplary embodiment of a system 10000;

FIG. 11 is a photograph of an exemplary embodiment of a system 11000;

FIG. 12 is a photograph of an exemplary electric actuator 12000;

FIG. 13 is a photograph of an exemplary electric actuator 13000;

FIG. 14 is a photograph of an exemplary embodiment of a system 14000;

FIG. 15 is a photograph of an exemplary embodiment of a system 15000; and

FIG. 16 is a photograph of an exemplary embodiment of a system 16000.

### DETAILED DESCRIPTION

Certain exemplary embodiments can provide a system comprising a Trailer. The Trailer is coupleable to a tractor. The Trailer comprises a pair of dollies. Each of the pair of dollies can comprise a support shaft and a footpad. The system comprises a single shaft that is coupled to a jack of each of the pair of dollies.

Tractor-trailer systems are used extensively for transportation and delivery of goods and products. Trailers are releasably coupled for transport and can be uncoupled for certain exemplary pickups or deliveries.

In order to facilitate use, a trailer can be equipped with at least one pair of dollies. The pair of dollies can be located near a front end of the trailer. Each dolly of pair of dollies comprises a footpad on a support shaft that is retracted to an elevated position when trailer is being towed by a tractor. Prior to uncoupling trailer from the tractor, the support shaft is extended such that a footpad on each of the dollies contacts a surface on which the trailer rests. Thereby, the trailer can be supported by the pair of dollies such that an elevation of the trailer can remain substantially similar to that of the trailer while it is being towed by the tractor.

Certain exemplary embodiments provide devices, systems, and/or methods to extend and/or retract the pair of dollies via a means other than a human operating a manual jack or crank. For example, the pair of dollies can be actuated via a turning of a single shaft. In such embodiments, an electric motor can be operatively coupled to the single shaft, such as, directly coupled, coupled via a sprocket and chain drive, coupled via a socket and powered wrench arrangement, and/or coupled via sheaves and a drive belt. In such embodiments, operation of the electric motor, or the equivalent thereof, can cause each support shaft comprised by the pair of dollies to extend or retract in accordance with whether the trailer is being prepared to be towed or being prepared to be uncoupled from a tractor. The electric motor can be manually controlled by a human operator directly viewing the trailer and the pair of dollies.

The electric motor is selected to provide sufficient torque to raise and lower dollies. For example, the electric motor can have a horsepower rating of approximately 0.3, 0.4, 0.5, 0.75, 1.0, 1.25, 1.5, 1.75, 2.0, 2.5, 3, 4, 5 and/or any value or subrange therebetween.

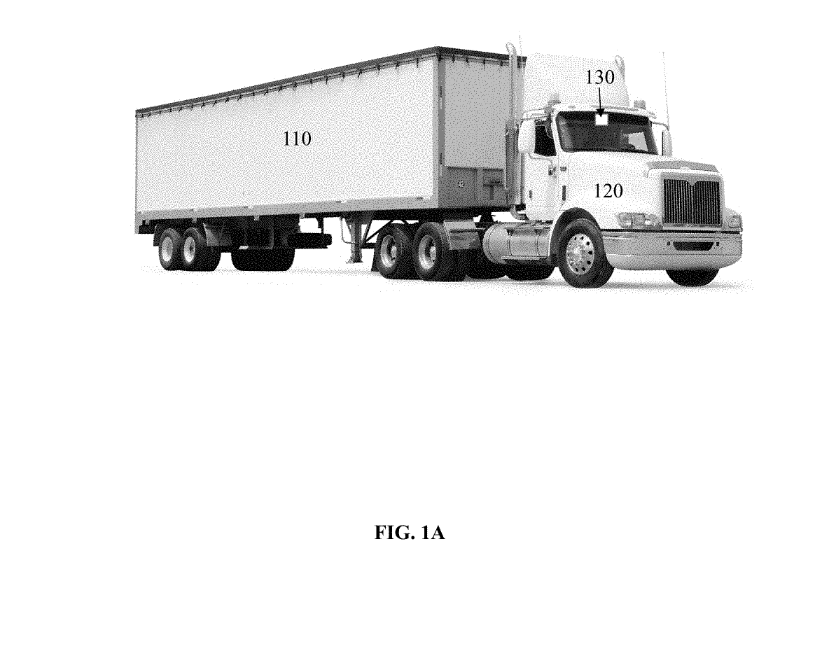

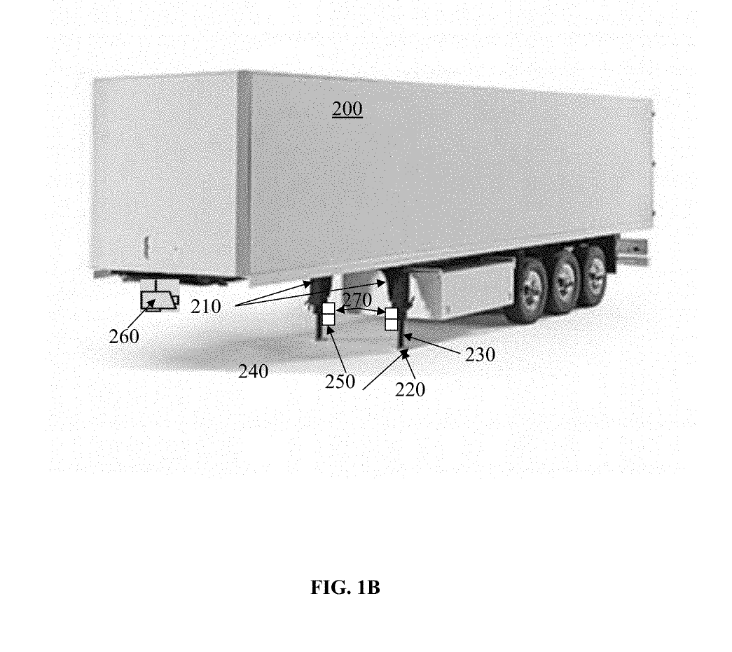

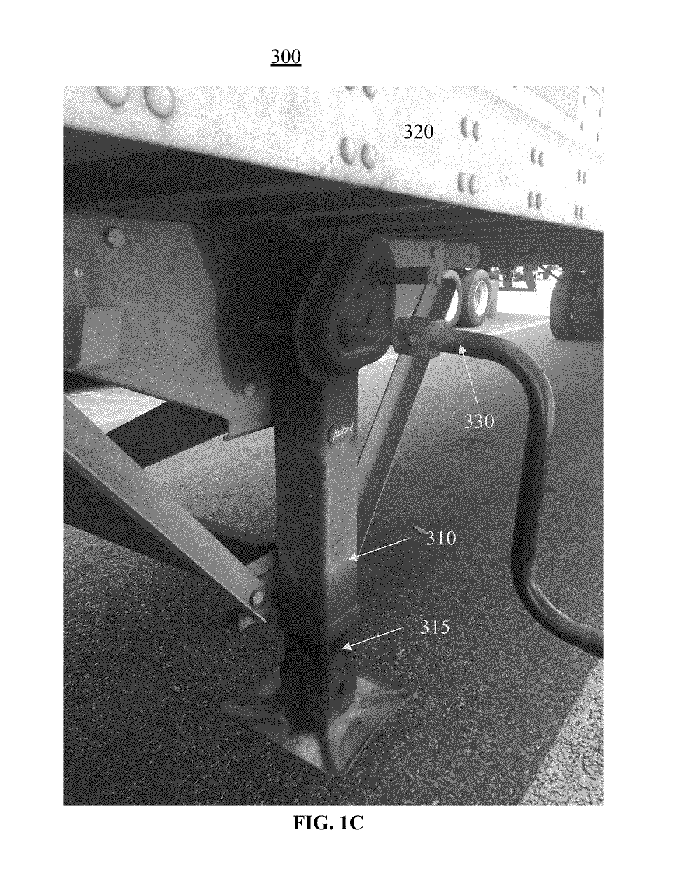

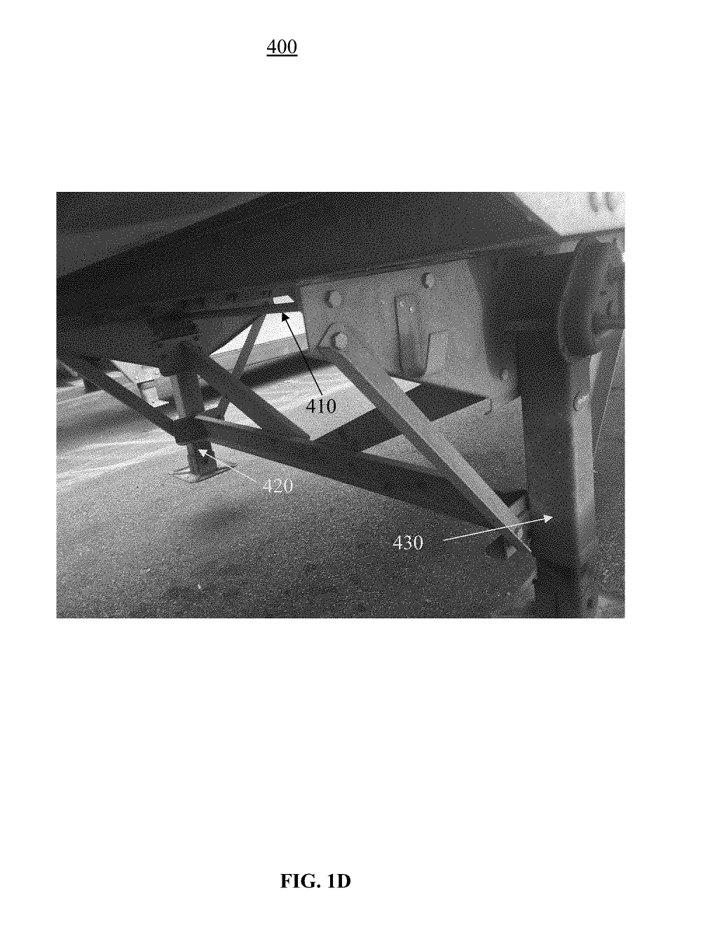

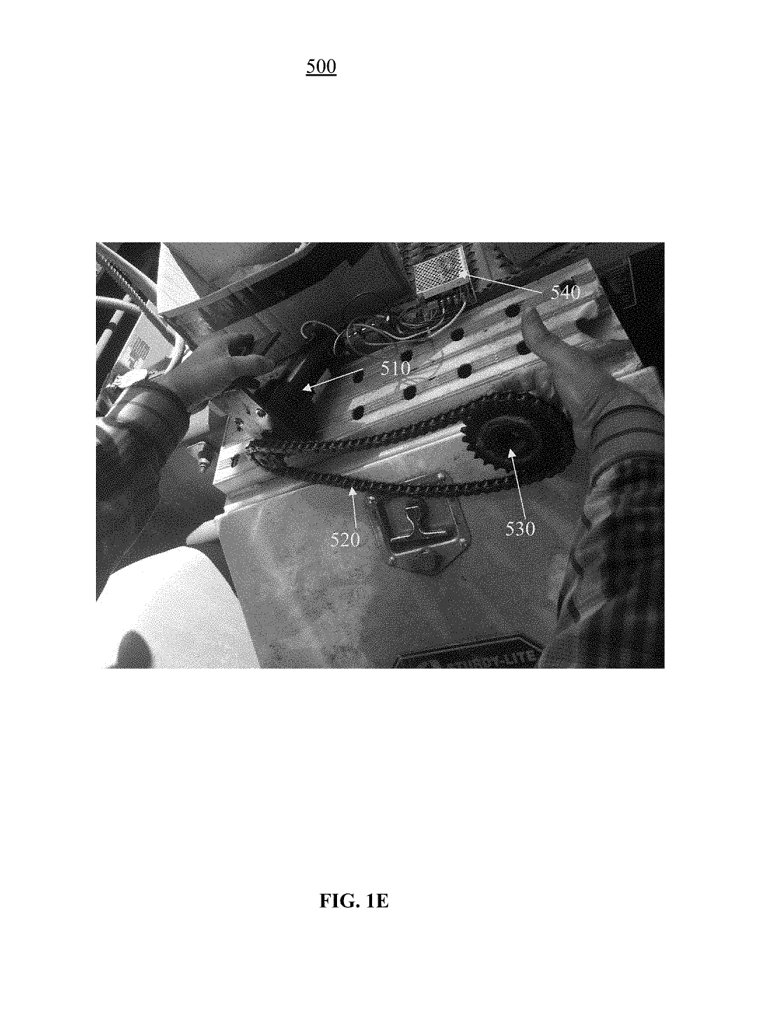

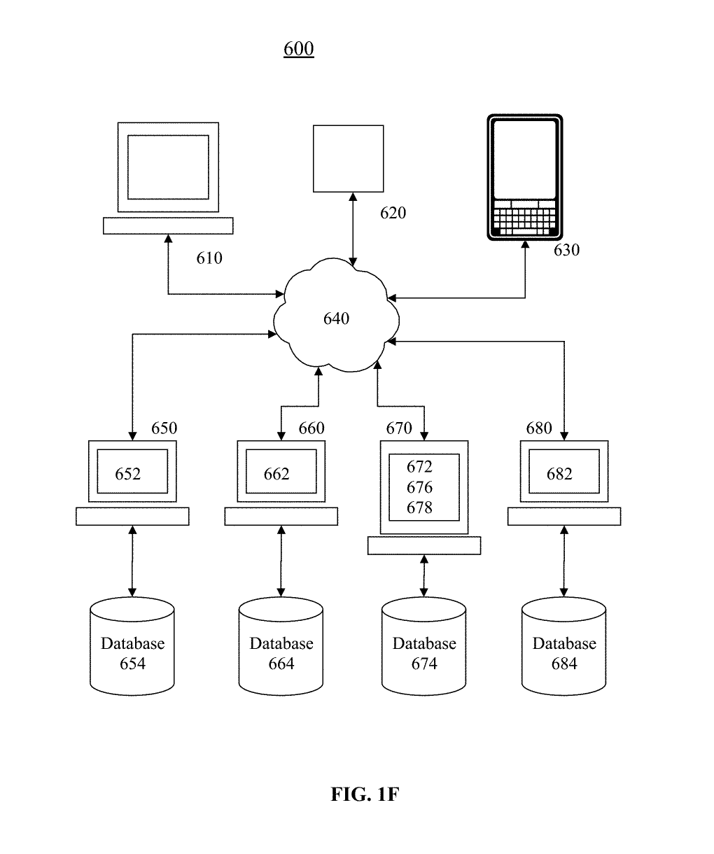

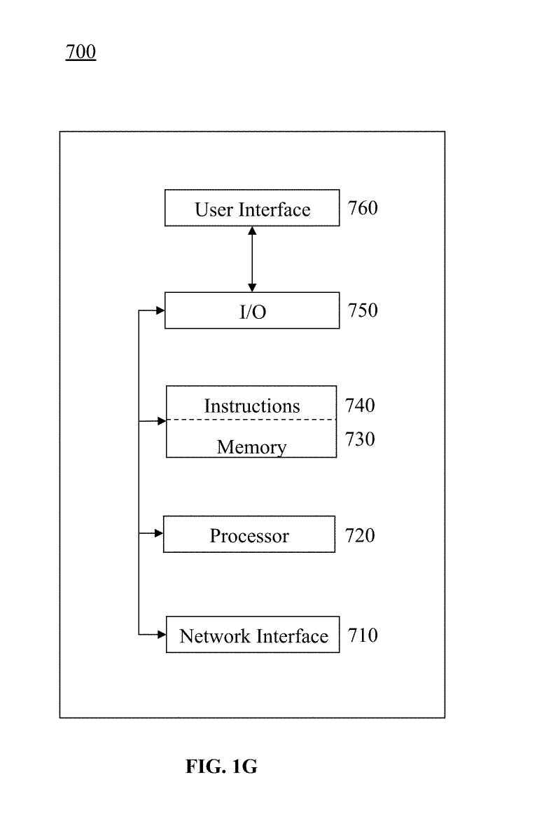

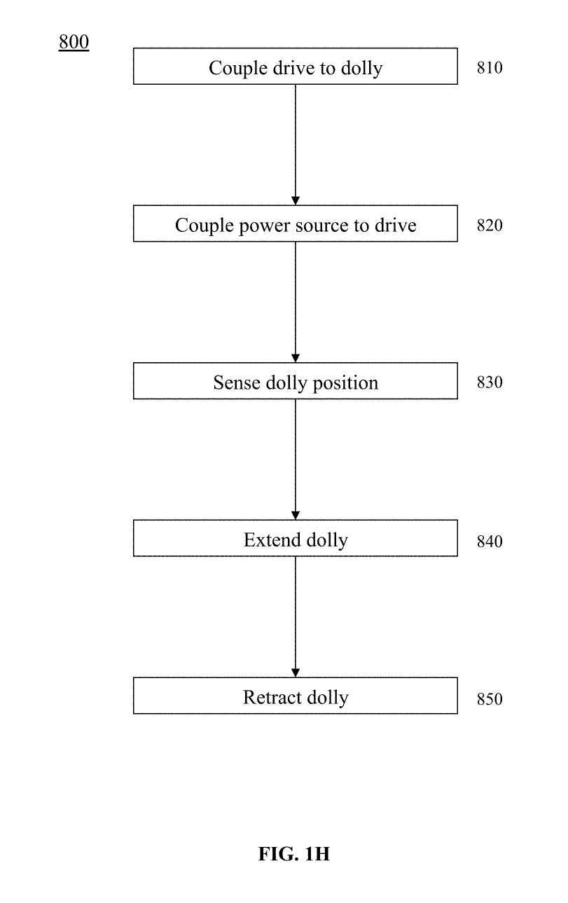

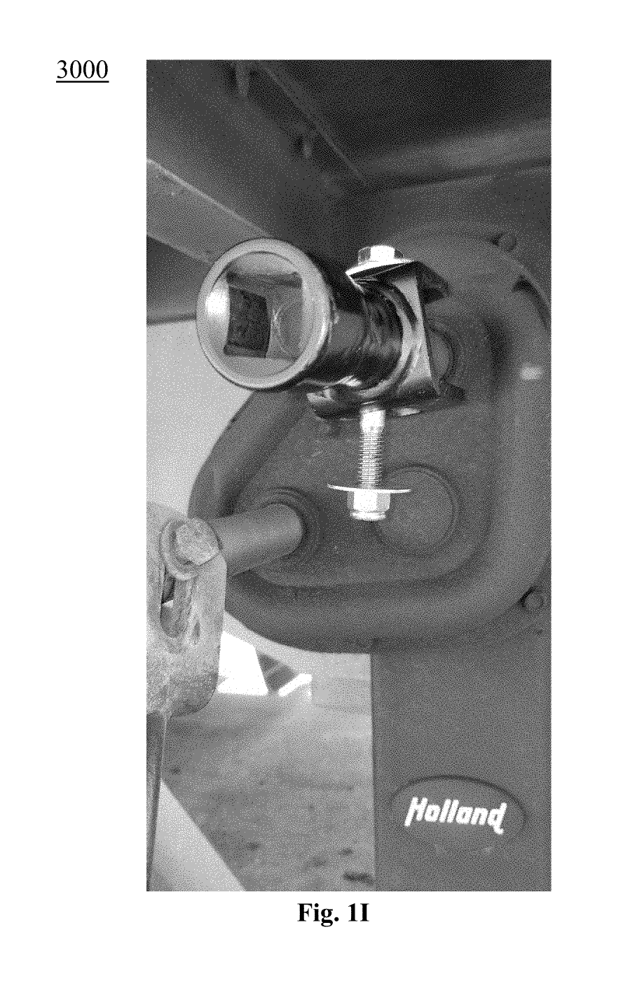

FIG. 1A is a photograph of an exemplary embodiment of a system 100, which comprises a trailer 110 and a tractor 120. Tractor-trailer systems, such as system 100 are used extensively for transportation and delivery of goods and products. Trailer 110 is releasably coupled for transport and can be uncoupled for certain exemplary pickups or deliveries.

FIG. 1B is a photograph of an exemplary embodiment of a trailer 200. In order to facilitate use, trailer 200 can be equipped with a pair of dollies 210. Pair of dollies 210 can be located near a front end of trailer 200. Each dolly of pair of dollies 210 comprises a footpad 220 on a support shaft 230 that is retracted to an elevated position when trailer 200 is being towed by a tractor. Prior to uncoupling trailer 200 from the tractor, support shaft 230 is extended such that footpad 220 on each of the dollies contacts a surface 240 on which trailer 200 rests. Thereby, trailer 200 can be supported by pair of dollies 210 such that an elevation of trailer 200 can remain substantially similar to that of trailer 200 while it is being towed by the tractor.

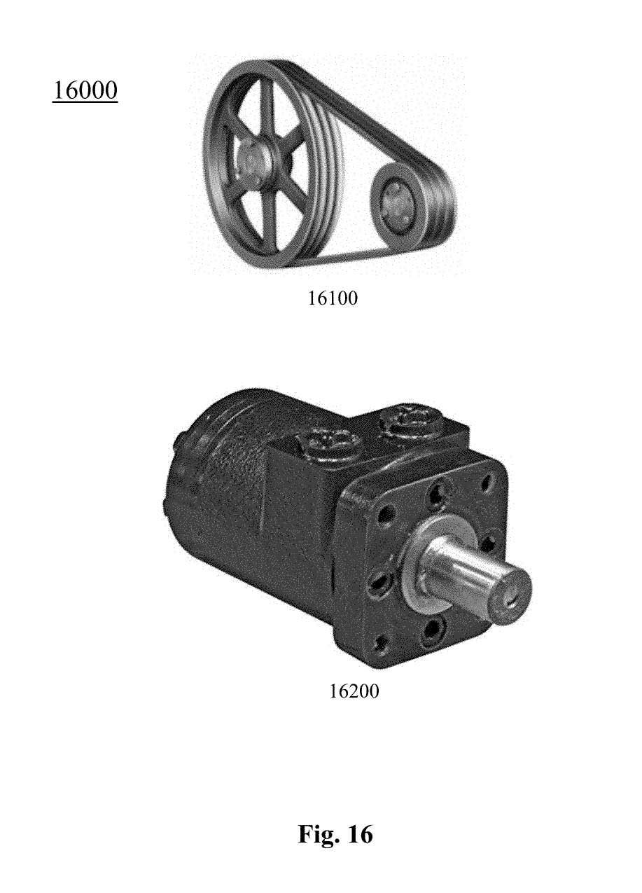

Certain exemplary embodiments provide devices, systems, and/or methods to extend and/or retract pair of dollies 210 via a means other than a human operating a jack (e.g., jack 330 of FIG. 1C). For example, pair of dollies 210 can be actuated via a turning of a single shaft (e.g., single shaft 410 of FIG. 1D). In such embodiments, an electric motor (e.g., electric motor 510 of FIG. 1E) can be operatively coupled to the single shaft (e.g., single shaft 410 of FIG. 1D), such as, directly coupled, coupled via a drive (e.g., drive 520 of FIG. 1E, wherein sprocket 530 is coupled to, e.g., single shaft 410 of FIG. 1D), and/or coupled via a sheaves and a belt (e.g., sheaves and belt drive 16100 of FIG. 16). In such embodiments, operation of the electric motor can cause each support shaft 230 comprised by pair of dollies 210 to extend or retract in accordance with whether the trailer is being prepared to be towed or being prepared to be uncoupled from a tractor. The electric motor (e.g., electric motor 510 of FIG. 1E) can be manually controlled by a human operator directly viewing trailer 200 and pair of dollies 210.

Certain exemplary embodiments comprise one or more of position sensor 250 that provide signals indicative of a position of support shaft 230 on each dolly relative to a fully extended or fully retracted position. In certain exemplary embodiments, the human operator can view pair of dollies 210 and the position of each support shaft 230 and footpad 220 via video (e.g., via a camera 260) and/or via a rendering of information transmitted via position sensor 250 comprised by each of pair of dollies 210. Thereby, pair of dollies 210 support shaft 230 can be extended and/or retracted safely and in compliance with safety rules and/or regulations.

In certain exemplary embodiments, the electric motor (e.g., electric motor 510 of FIG. 1E) can be automatically controlled via an information device (e.g., information device 610 of FIG. 1F). For example, in applications where autonomous tractors are utilized, an information device (e.g., information device 610 of FIG. 1F) can cause each dolly support shaft 230 to be extended such that each footpad 220 is in contact with surface 240 upon which trailer 200 rests. Via such automatic control, trailer 200 can be automatically uncoupled from a tractor. For example, trailer 200 can be automatically positioned at a predetermined location via an automatic navigation system. Upon detecting that the trailer should be uncoupled, the information device (e.g., information device 610 of FIG. 1F) can sense whether there is any motion or other indication of a human in proximity to pair of dollies 210. If a human presence is detected, the information device can cause an alarm to sound, a regulatory entity to be signaled, or otherwise cause the human to relocate to a position where there is no substantial danger from actuation of either dolly support shaft 230. Thereupon, the information device can send a signal to cause each dolly support shaft 230 to be extended such that each footpad 220 is in contact with surface 240 upon which trailer 200 rests.

Similarly, when it is time for a tractor to be coupled to a trailer for towing, a signal can be sent via the information device to position a tractor to be coupled to trailer 200. The tractor positions itself against trailer 200 and the information device causes trailer 200 to become coupled to trailer 200. Subsequent to trailer 200 being coupled to a tractor, the information device (e.g., information device 610 of FIG. 1F) can cause support shaft 230 to retract to a position at which trailer 200 can be towed.

In certain exemplary embodiments, controls for actuating support shaft 230 of pair of dollies 210 can be mounted in a cab of a tractor coupled to trailer 200. For example, a controller (e.g., controller 540 of FIG. 1E) can be electrically coupled to an electric motor (e.g., electric motor 510 of FIG. 1E) and placed in a cab of the tractor coupled to trailer 200. Thereby a human in the cab of the tractor coupled to trailer 200 can actuate support shaft 230 of pair of dollies 210 while remaining in that cab. In certain exemplary embodiments, the human can view pair of dollies 210 while support shaft 230 are actuated via images transmitted from camera 260.

FIG. 1C is a photograph of an exemplary embodiment of a system 300, which is the underside of an exemplary trailer 320 coupleable to a tractor. System 300 can be utilized to transport goods from a first location to a second location. System 300 comprises a dolly 310 (sometimes called an outrigger), which can be raised while trailer 320 is being towed by the tractor. Jack 330 can be extended from a stored position to an active position for cranking. Jack 330 can have a high speed mode and a high torque mode. The mode of jack 330 is set by engaging one of two gears (hidden in the photograph shown in FIG. 1C) that is utilized to cause extension and retraction of a support shaft 315 of dolly 310.

FIG. 1D is a photograph of an exemplary embodiment of a system 400, which illustrates a shaft 410 that is utilized to cause both first dolly 420 and second dolly 430 to be actuated.

FIG. 1E is a photograph of an exemplary embodiment of a system 500, which comprises electric motor 510, sprocket and chain drive 520, sprocket 530, and controller 540.

FIG. 1F is a block diagram of an exemplary embodiment of a system 600, which can comprise a smartphone 630, an information device 610, tablet 620, a network 640, a first server 650, a second server 660, a third server 670, and a fourth server 680. First server 650 can comprise a first user interface 652 and can be coupled to a first database 654. Second server 660 can comprise a second user interface 662 and can be coupled to a second database 664. Third server 670 can comprise a third user interface 672, a processor 676, machine instructions 678, and can be coupled to a third database 674. Fourth server 680 can comprise a fourth user interface 682 and can be coupled to a fourth database 684. Any of the methods and/or steps thereof can be carried out in whole or in part by tablet 620, smartphone 630, information device 610 and/or first server 650. Second server 660, third server 670, and/or fourth server 680 can each be associated with implementation of an autonomous tractor/trailer control system via which trailer dolly heights can be adjusted manually and/or automatically. In certain exemplary embodiments, system 600 can be used to implement one or more methods disclosed herein.

FIG. 1G is a block diagram of an exemplary embodiment of an information device 700, which in certain operative embodiments can comprise, for example, information device 610 of FIG. 1F. Information device 700 can comprise any of numerous circuits and/or components, such as for example, one or more network interfaces 710, one or more processors 720, one or more memories 730 containing instructions 740, one or more input/output (I/O) devices 750, and/or one or more user interfaces 760 coupled to one or more I/O devices 750, etc.

In certain exemplary embodiments, via one or more user interfaces 760, such as a graphical user interface, a user can view a rendering of information related to actuating and/or controlling trailer dollies.

FIG. 1H is a flowchart of an exemplary embodiment of a method 800. At activity 810, a drive can be coupled to a dolly. The drive can comprise and electric motor, gas actuator, and/or a pneumatic actuator, etc. At activity 820, a power source can be coupled to the drive. In certain exemplary embodiments, the power source can transfer electrical energy to an electric motor. In other embodiments, a pressurized fluid source, such as a pressurized gas or liquid source, can be coupled to a gas and/or pneumatic actuator. At activity 830, a dolly position can be sensed. At activity 840, the dolly can be extended via a support shaft. At activity 850, the dolly can be retracted via a support shaft.

FIG. 1I is a photograph of an exemplary embodiment of a system 1000, which illustrates a socket coupled (e.g., fixedly coupled) to a trailer dolly shaft. An electrically and/or pneumatically energized device (e.g., an impact wrench and/or drill) can be coupled to the socket to raise and/or lower trailer dollies.

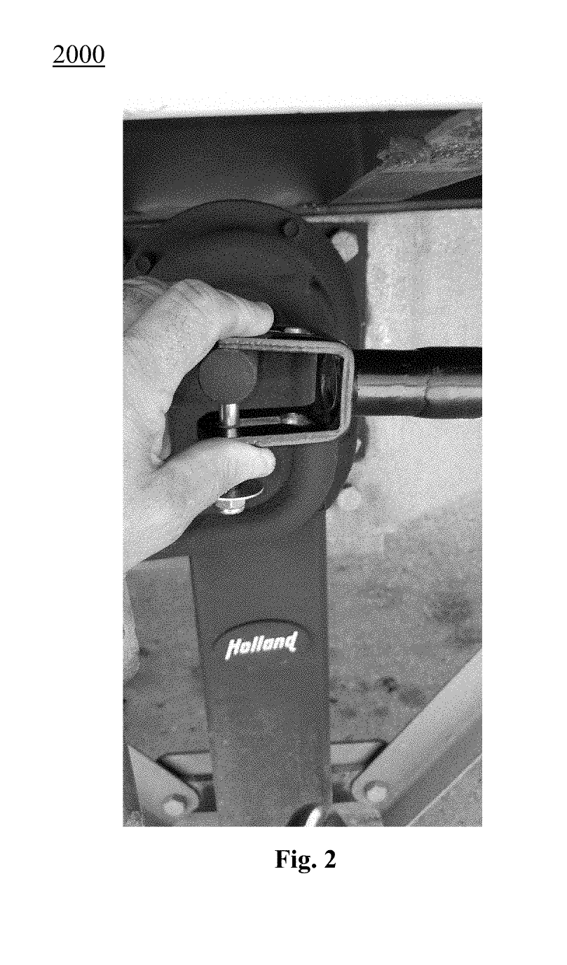

FIG. 2 is a photograph of an exemplary embodiment of a system 2000, which illustrates a handle coupled (e.g., releasably coupled) to a shaft that is coupled to trailer dollies to provide an ability for a user to raise and/or lower one or more of the dollies.

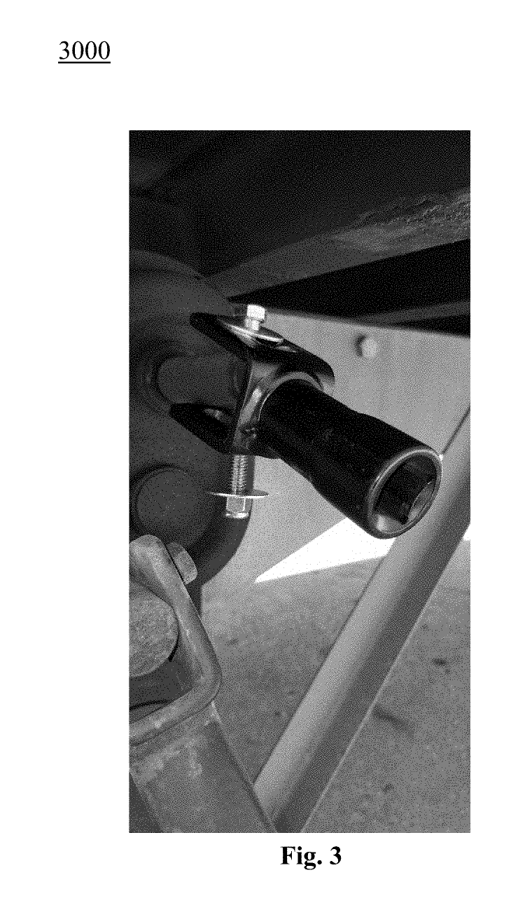

FIG. 3 is a photograph of an exemplary embodiment of a system 3000, which illustrates a socket fixedly coupled to a trailer dolly shaft. An electrically and/or pneumatically energized device (e.g., and impact wrench) can be coupled to the socket to raise and/or lower trailer dollies.

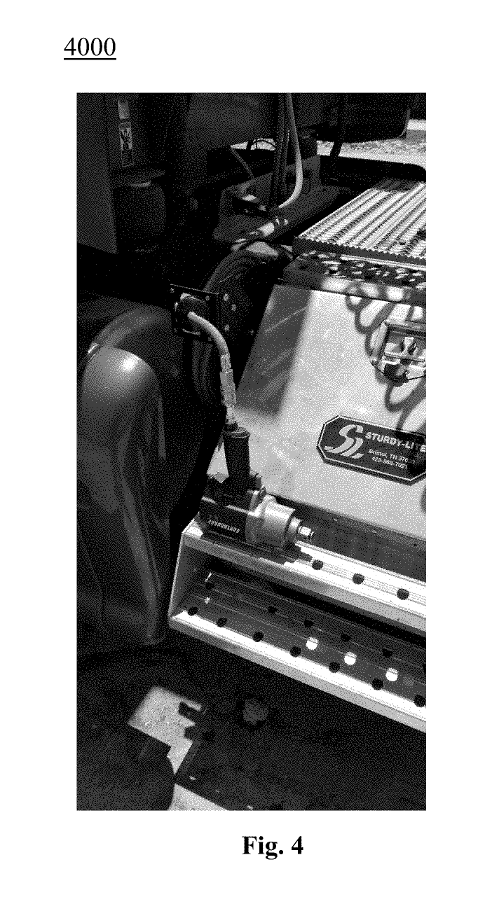

FIG. 4 is a photograph of an exemplary embodiment of a system 4000, which illustrates an exemplary pneumatic actuator (also called an impact wrench) that can be used to provide motive force to turn a shaft to raise and/or lower trailer dollies.

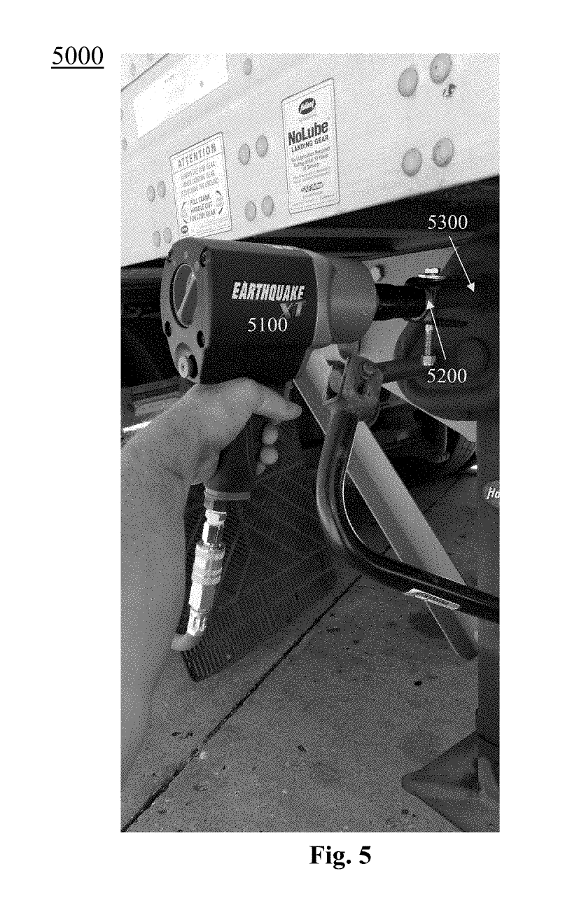

FIG. 5 is a photograph of an exemplary embodiment of a system 5000, which illustrates an exemplary pneumatic actuator 5100 that can be used to provide motive force to turn a shaft to raise and/or lower trailer dollies that have a drive coupled to a socket 5200. In the illustrated embodiment, pneumatic actuator 5100 is coupled to socket 5200 coupled to a shaft. By turning the shaft via the socket, trailer dollies can be raised and/or lowered.

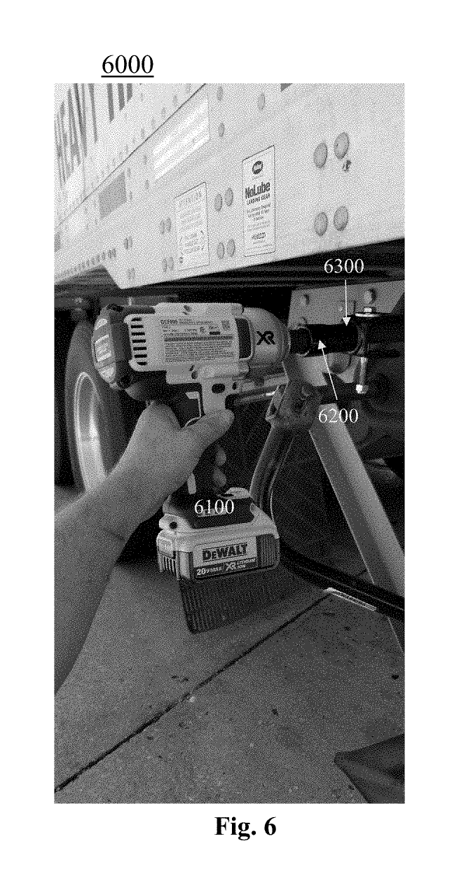

FIG. 6 is a photograph of an exemplary embodiment of a system 6000, which illustrates an exemplary pneumatic actuator 6100, which can be used to provide motive force to turn a shaft 6300 to raise and/or lower trailer dollies. In the illustrated embodiment, pneumatic actuator 6100 is coupled to a socket 6200 that is coupled to shaft 6300. By turning shaft 6300, the trailer dollies can be raised and/or lowered.

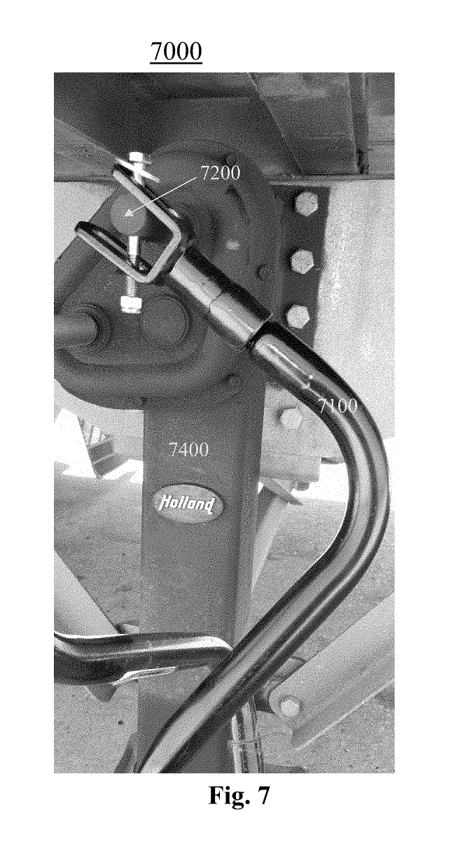

FIG. 7 is a photograph of an exemplary embodiment of a system 7000, which illustrates a handle 7100 coupled to a shaft 7200. Turning shaft 7200 causes one or more trailer dollies (e.g., trailer dolly 7400) can be raised and/or lowered.

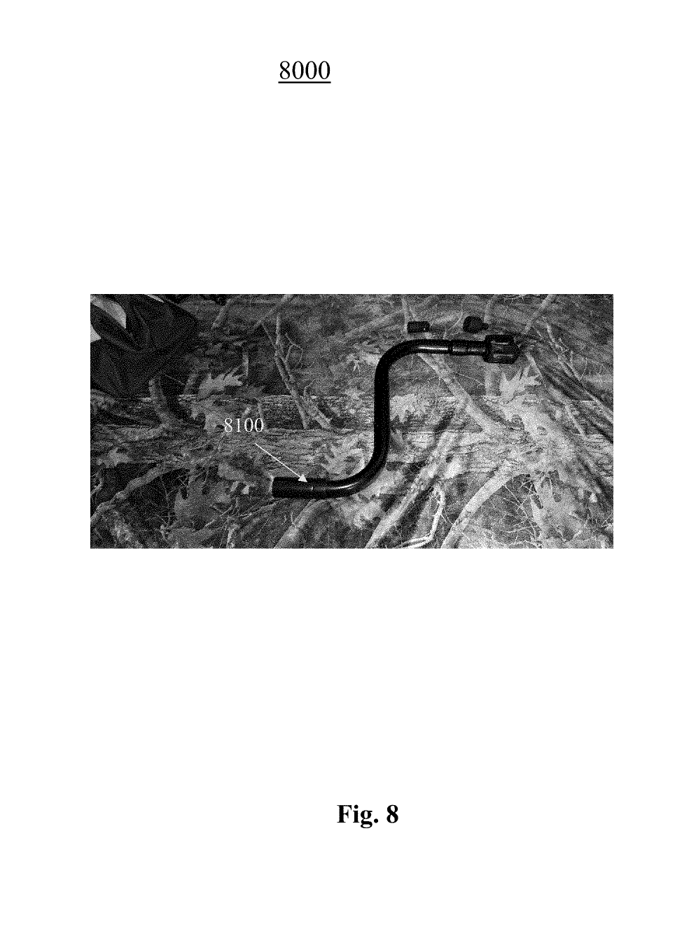

FIG. 8 is a photograph of an exemplary embodiment of a system 8000, which illustrates an exemplary handle and coupling attachments 8100 that can be used to raise and/or lower trailer dollies.

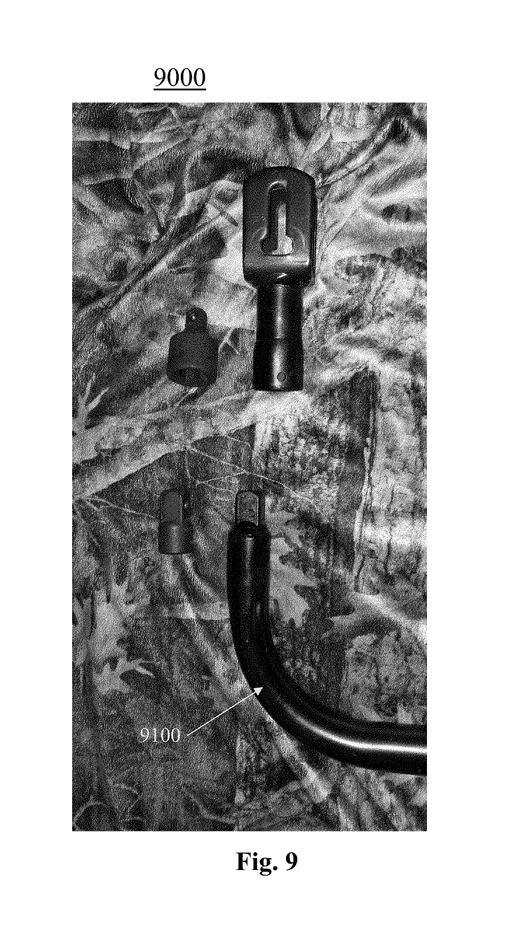

FIG. 9 is a photograph of an exemplary embodiment of a system 9000, which illustrates an exemplary handle and coupling attachments 9100 that can be used to raise and/or lower trailer dollies.

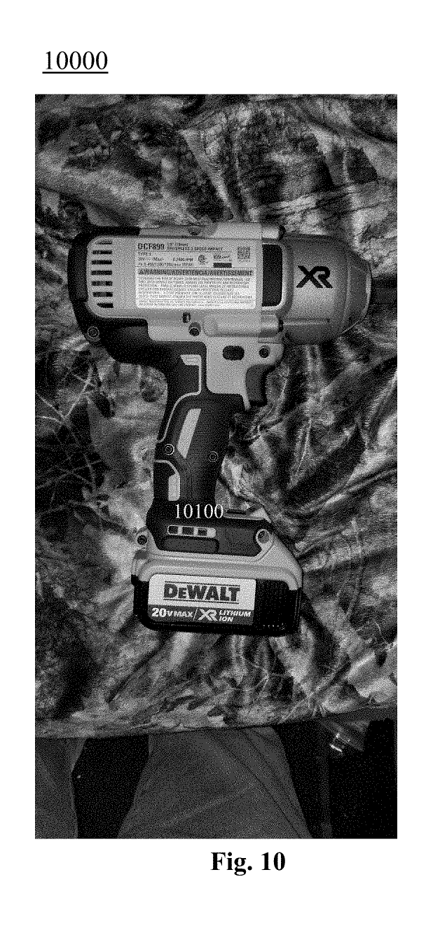

FIG. 10 is a photograph of an exemplary embodiment of a system 10000, which illustrates an exemplary battery powered and rechargeable electric actuator 10100. Electric actuator 10100 can be releasably coupled to a socket coupled to a shaft to raise and/or lower trailer dollies.

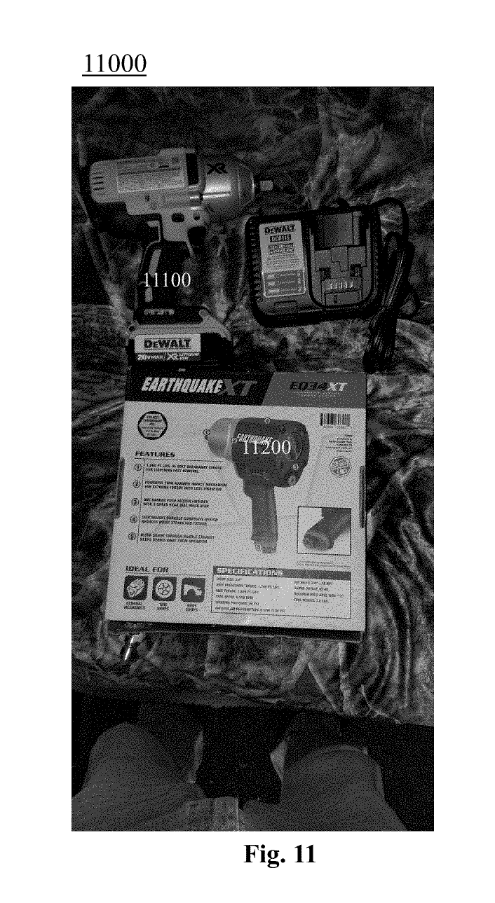

FIG. 11 is a photograph of an exemplary embodiment of a system 11000, which illustrates an exemplary electric actuator 11100 and an exemplary pneumatic actuator 11200. Electric actuator 11100 and/or pneumatic actuator 11200 can be releasably coupled to a shaft to raise and/or lower trailer dollies.

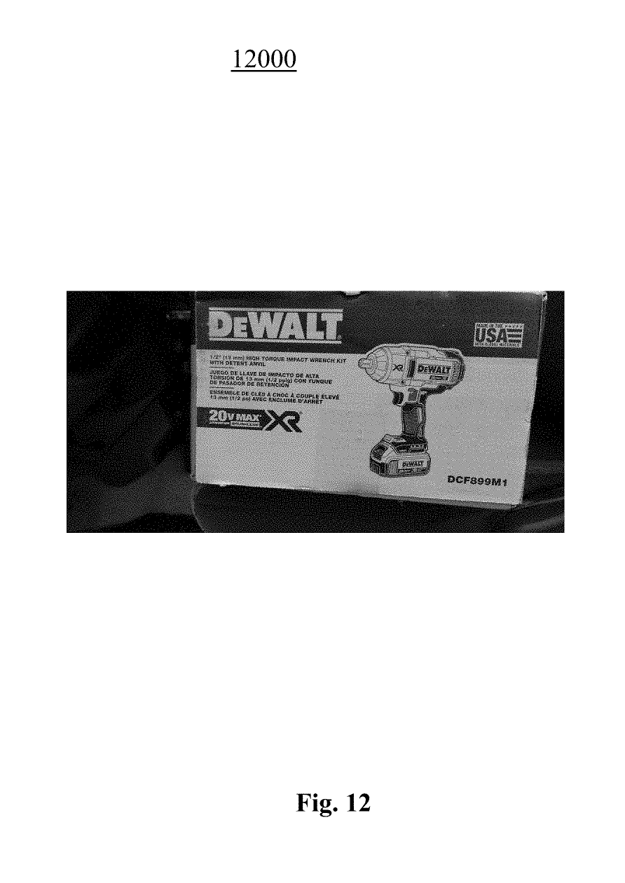

FIG. 12 is a photograph of an exemplary embodiment of an exemplary electric actuator 12000. Electric actuator 12000 can be releasably coupled to a shaft to raise and/or lower trailer dollies.

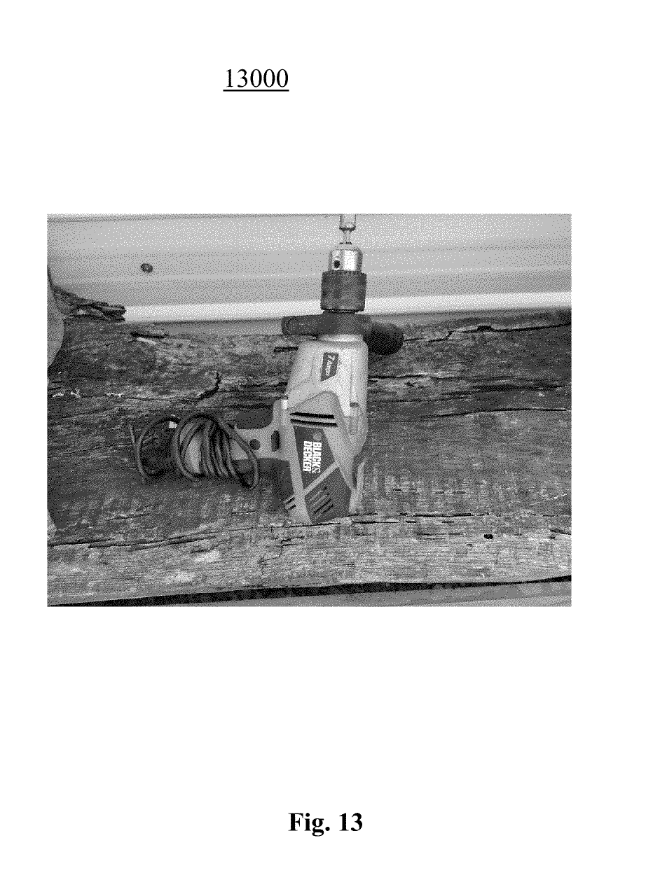

FIG. 13 is a photograph of an exemplary electric actuator 13000, which is an electric drill with attachments. Electric actuator 13000 can be releasably coupled to a shaft to raise and/or lower trailer dollies.

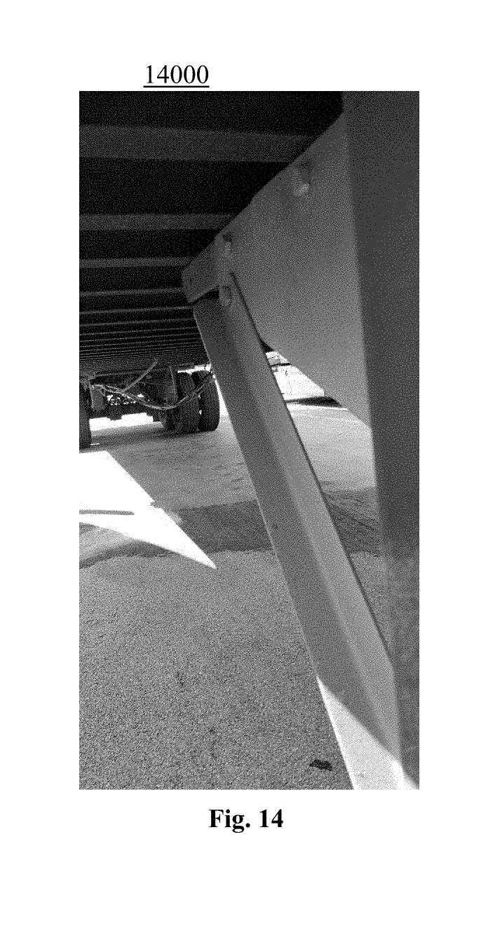

FIG. 14 is a photograph of an exemplary embodiment of a system 14000, which illustrates an underside of an exemplary trailer that comprises a pair of dollies.

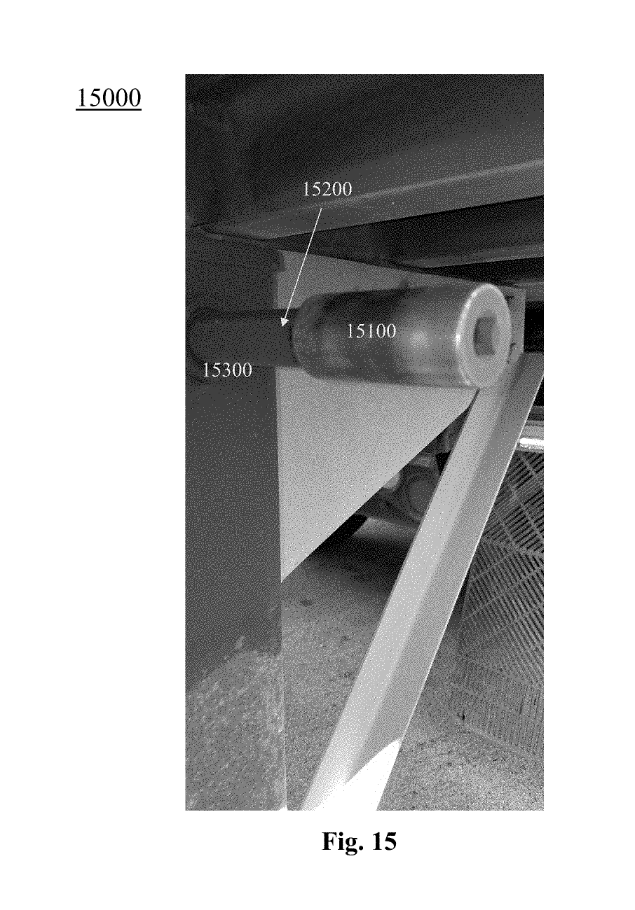

FIG. 15 is a photograph of an exemplary embodiment of a system 15000, which illustrates a socket 15100 fixedly coupled to a trailer dolly shaft 15200. An electrically and/or pneumatically energized actuator (e.g., an impact wrench and/or drill) can be coupled to socket 15100 to raise and/or lower trailer dolly 15300.

FIG. 16 is a photograph of an exemplary embodiment of a system 16000, which illustrates sheave and belt drive 16100 and hydraulic actuator 16200. One of belt drive 16100 and hydraulic actuator 16200 can be utilized to raise and/or lower trailer dollies. Hydraulic actuator 16200 can be powered by a tractor hydraulic system.

Certain exemplary embodiments provide a system, which comprises:
a trailer (see, e.g., trailer 110 of FIG. 1A), the trailer coupleable to a tractor (see, e.g., tractor 120 of FIG. 1A), the trailer comprising a pair of dollies, each of the pair of dollies (see, e.g., pair of dollies 210 of FIG. 1B) comprising a support shaft (see, e.g., support shaft 230 of FIG. 1B) and a footpad (see, e.g., footpad 220 of FIG. 1B);
a single shaft (see, e.g., single shaft 410 of FIG. 1D) that is coupled to a jack (see, e.g., jack 330 of FIG. 1C) of each of the pair of dollies;
a drive (see, e.g., drive 520 of FIG. 1E) coupled to the single shaft, the drive comprising an electric motor (see, e.g., electric motor 510 of FIG. 1E), the electric motor constructed to raise or lower both of the pair of dollies;
a camera (see, e.g., camera 260 of FIG. 1B), the camera constructed to cause transmission of a signal that comprises an image in proximity to the trailer;
a position sensor (see, e.g., position sensor 250 of FIG. 1B), the position sensor constructed to cause transmission of a signal that indicates a degree of extension of at least one of the support shaft or the footpad; and/or
a wireless transceiver (see, e.g., wireless transceiver 270 of FIG. 1B), the wireless transceiver can be constructed to:
   receive a signal that causes the electric motor to raise or lower both of the pair of dollies;
   receive a signal that causes an alarm to annunciate if a human is detected in proximity to one of the pair of dollies;
   receive a signal that causes the electric motor to raise or lower both of the pair of dollies, wherein the signal is automatically transmitted responsive to a signal from the tractor, wherein the tractor is positioned relative to the trailer without a driver.

The electric motor can be coupled to the single shaft via:
a chain and sprockets;
a belt and sheaves; and/or
a socket.

The electric motor can be controlled via a switch (see, e.g., switch 130 of FIG. 1A) comprised by the tractor.

The tractor can be coupled to the trailer.

The drive can comprise a socket, the socket constructed to raise or lower both of the pair of dollies when rotated. The drive can be coupled to:
a pneumatic actuator, the pneumatic actuator coupled to the socket to raise or lower both of the pair of dollies;
a hydraulic actuator, the hydraulic actuator coupled to the socket to raise or lower both of the pair of dollies; or
an electric actuator, the electric actuator coupled to the socket to raise or lower both of the pair of dollies.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
actuator—a mechanical device that uses energy to produce a force in a rotating motion.
adapter—a device used to effect operative compatibility between different parts of one or more pieces of an apparatus or system.
alarm—a warning of existing or approaching danger.
and/or—either in conjunction with or in alternative to.
apparatus—an appliance or device for a particular purpose.
associate—to join, connect together, and/or relate.
automatically—acting or operating in a manner essentially independent of external influence or control. For example, an automatic light switch can turn on upon “seeing” a person in its view, without the person manually operating the light switch.
automatically—acting or operating in a manner essentially independent of external influence or control. For example, an automatic light switch can turn on upon “seeing” a person in its view, without the person manually operating the light switch.
belt—a flexible band used to drive a part of a machine.
camera—an instrument constructed to record and/or capture still and/or moving images.
can—is capable of, in at least some embodiments.
cause—to bring about.
chain—a series of metal links coupled one another and used for transmission of mechanical power.
circuit—an electrically conductive pathway and/or a communications connection established across two or more switching devices comprised by a network and between corresponding end systems connected to, but not comprised by the network.
comprising—including but not limited to.
configure—to make suitable or fit for a specific use or situation.
connect—to join or fasten together.
constructed to—made to and/or designed to.
convert—to transform, adapt, and/or change.
couple—to link in some fashion.
coupleable—capable of being joined, connected, and/or linked together.
define—to establish the outline, form, or structure of
degree—extent.
detect—to sense or perceive.
determine—to obtain, calculate, decide, deduce, and/or ascertain.
device—a machine, manufacture, and/or collection thereof.
dolly—a jack stand coupled to a trailer. The jack stand raised and lowered via rotation of a drive shaft, such as a drive shaft that rotates a ring gear engaged to a pinion gear coupled to the jack stand.
drive—a system by which power is transmitted in a machine.
driver—a human operator of a tractor.
electric—utilizing electricity as an energy source.
electric motor—an electrical machine that converts electrical energy into rotational mechanical energy.
extension—expansion or contraction.
footpad—an end of a dolly leg that has a substantially planar surface constructed to contact the earth or a support surface above the surface of the earth.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
hydraulic—utilizing liquid pressure.
image—an at least two-dimensional representation of an object and/or phenomenon.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
install—to connect or set in position and prepare for use.
jack—a lifting device.
lower—to raise in elevation relative to the earth's surface.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
motorize—to equip with a rotating electrical motor, the electrical motor constructed to actuate the system to which the electrical motor is coupled.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
pair—two similar things used together.
plurality—the state of being plural and/or more than one.
pneumatic—utilizing gas pressure.
position—a location.
predetermined—established in advance.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
provide—to furnish, supply, give, and/or make available.
proximity—close to something.
raise—to lift in elevation relative to the earth's surface.
receive—to get, take, acquire, and/or obtain.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
sensor—a device used to measure a physical quantity (e.g., temperature, pressure, capacitance, proximity to something else, and/or loudness, etc.) and convert that physical quantity into a signal of some kind (e.g., voltage, current, power, etc.).
set—a related plurality.
shaft—a rod in a mechanical drive.
sheave—a grooved pulley wheel.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
socket—a tool that defines a machine recess and a drive recess; the machine recess is coupleable to a rotatable machine component; the drive recess is coupleable to a drive that is used to rotate the socket.
sprocket—a toothed wheel.
store—to place, hold, and/or retain.
substantially—to a great extent or degree.
support—to bear the weight of, especially from below.
switch—a device used to close or open an electric circuit or to divert current from one conductor to another.
system—a collection of mechanisms, devices, machines, articles of manufacture, processes, data, and/or instructions, the collection designed to perform one or more specific functions.
tractor—a powered vehicle constructed to tow a trailer.
trailer—a substantially unpowered vehicle releasably coupleable to, and towable by, a powered vehicle.
transceiver—a device comprising both a transmitter and a receiver that are combined and share common circuitry or a single housing.
transmit—to send as a signal, provide, furnish, and/or supply.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
wireless—any data communication technique that utilizes electromagnetic waves emitted by an antenna to communicate data (i.e., via an unguided medium), including such data communication techniques as sonar, radio, cellular, cellular radio, digital cellular radio, ELF, LF, MF, HF, VHF, UHF, SHF, EHF, radar, microwave, satellite microwave, laser, infrared, etc., and specifically excluding human voice radio transmissions, the data communication technique having a carrier frequency ranging from about 1 Hz to about 2×10¹⁴ Hz (about 200 teraHertz), including all values therebetween, such as for example, about 40 Hz, 6.010 kHz, 8.7 MHz, 4.518 GHz, 30 GHz, etc. and including all subranges therebetween, such as for example, from about 100 kHz to about 100 MHz, about 30 MHz to about 1 GHz, about 3 kHz to about 300 GHz, etc. Wireless communications can include analog and/or digital data, signals, and/or transmissions.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a trailer, the trailer coupleable to a tractor, the trailer comprising a pair of dollies, each of the pair of dollies comprising a support shaft and a footpad;
a single shaft that is coupled to a jack of each of the pair of dollies; and
a drive coupled to the single shaft, the drive comprising an electric motor, the electric motor constructed to raise or lower both of the pair of dollies.

2. The system of claim 1, wherein:
the electric motor is coupled to the single shaft via a chain and sprockets.

3. The system of claim 1, wherein:
the electric motor is coupled to the single shaft via a belt and sheaves.

4. The system of claim 1, wherein:
the electric motor is coupled to the single shaft via a socket.

5. The system of claim 1, wherein:
the electric motor is controlled via a switch comprised by the tractor.

6. The system of claim 1, wherein:
the tractor is coupled to the trailer.

7. The system of claim 1, further comprising:
a camera, the camera constructed to cause transmission of a signal that comprises an image in proximity to the trailer.

8. The system of claim 1, further comprising:
a position sensor, the position sensor constructed to cause transmission of a signal that indicates a degree of extension of at least one of the support shaft or the footpad.

9. The system of claim 1, further comprising:
a wireless transceiver, the wireless transceiver constructed to receive a signal that causes the electric motor to raise or lower both of the pair of dollies.

10. The system of claim 1, further comprising:
a wireless transceiver, the wireless transceiver constructed to receive a signal that causes an alarm if a human is detected in proximity to one of the pair of dollies.

11. The system of claim 1, further comprising:
a wireless transceiver, the wireless transceiver constructed to receive a first signal that causes the electric motor to raise or lower both of the pair of dollies, wherein the signal is automatically transmitted responsive to a second signal from the tractor, wherein the tractor is positioned relative to the trailer without a driver.

12. A system comprising:
a trailer, the trailer coupleable to a tractor, the Trailer comprising a pair of dollies, each of the pair of dollies comprising a support shaft and a footpad;
a single shaft that is coupled to a jack of each of the pair of dollies; and
a drive coupled to the single shaft, the drive comprising a socket, the socket constructed to raise or lower both of the pair of dollies when rotated.

13. The system of claim 12, further comprising:
a pneumatic actuator, the pneumatic actuator coupled to the socket to raise or lower both of the pair of dollies.

14. The system of claim 12, further comprising:
a hydraulic actuator, the hydraulic actuator coupled to the socket to raise or lower both of the pair of dollies.

15. The system of claim 12, further comprising:
an electric actuator, the electric actuator coupled to the socket to raise or lower both of the pair of dollies.
